(19) United States
(12) Patent Application Publication
(10) Pub. No.: US 2008/0164100 A1
(43) Pub. Date: Jul. 10, 2008

(54) Oil Path Structure

(75) Inventors: Yumi Iraha, Aichi-ken (JP); Masatoshi Adachi, Aichi-ken (JP); Kazutoshi Motoike, Aichi-ken (JP); Jun Ichiyanagi, Aichi-ken (JP)

Correspondence Address: OLIFF & BERRIDGE, PLC, P.O. BOX 320850, ALEXANDRIA, VA, 22320-4850, US

(73) Assignees: TOYOTA JIDOSHA KABUSHIKI KAISHA, TOYOTA-SHI, AICHI-KEN (JP); AISIN AW CO., LTD, ANJO-SHI, AICHI-KEN (JP)

(21) Appl. No.: 11/885,052

(22) PCT Filed: Mar. 22, 2006
(86) PCT No.: PCT/JP06/06401

§ 371 Date: Aug. 24, 2007

(30) Foreign Application Priority Data
Apr. 18, 2005 (JP) 2005-119364

(51) Int. Cl. F16H 57/04

(52) U.S. Cl. 184/6.4

(57) ABSTRACT

An oil path structure includes: a motor case having a joint surface and having a cooling oil path opened to the joint surface formed therein; a generator case having a cooling oil path formed therein and joined to the joint surface such that the cooling oil paths communicate with each other; an O-ring sealing between the cooling oil paths; and a plain washer limiting the flow rate of oil passing through the oil path. In the generator case, a recessed portion is formed at a position adjacent to the joint surface and on route of the cooling oil path. In the recessed portion, the O-ring in contact with the joint surface and the plain washer positioned on the side of O-ring opposite to the joint surface are arranged. The plain washer is sandwiched between the O-ring and a bottom surface. Thus, an oil path structure can be provided that ensures reliable sealing and allows flow rate adjustment with a simple structure.

### TECHNICAL FIELD

The present invention generally relates to an oil path structure and, more specifically, to an oil path structure having an oil amount adjusting member for limiting amount of oil arranged on the path.

### BACKGROUND ART

In relation to a conventional oil path structure, Japanese Patent Laying-Open No. 10-169773, for example, discloses a transmission operating device aimed at facilitating reduction in size and cost. The transmission operating device disclosed in this reference includes a cylinder housing having cylinder side flow passages formed therein, and a valve housing having valve side flow passages communicated with the cylinder side flow passages formed therein. At a mutual joint between the cylinder housing and the valve housing, an annular sealing member surrounding the outer periphery of the flow passage is arranged.

Further, Japanese Patent Laying-Open No. 9-79118 discloses a motor generator of internal combustion engine aimed at suppressing temperature increase of a stator coil without increasing the size or the number of parts.

In the transmission operating device disclosed in Japanese Patent Laying-Open No. 10-169773, pressure fluid is caused to flow through the cylinder side and valve side flow passages. For adjusting the flow rate of pressure fluid amid the flow path, a method may be adopted that uses a plug having a hole of smaller diameter than the flow path diameter. According to this method, at the mutual joint between the cylinder housing and the valve housing, the plug is press-fit into the flow path, and the pressed-in plug is fixed by caulking. It is noted, however, that at the mutual joint, the annular sealing member is arranged for sealing the flow passage between the two housings. Therefore, it is possible that the annular sealing member might be damaged by burr or fin of metal at the time of caulking and the sealing of flow passages might be lost. Further, at the position where the plug is press-fit, processing of a hole having a diameter different from that of the flow passage must be done in the housing, which requires high processing accuracy. This possibly leads to increased cost of manufacturing.

As another method of adjusting the flow rate of pressure fluid, it may be possible to perform hole processing on the housing such that the flow passage itself is made smaller. In that case, however, hole processing to a deep position with a drill of small diameter becomes necessary, and such processing might be difficult or substantially impossible.

### DISCLOSURE OF THE INVENTION

An object of the present invention is to solve the above-described problems and to provide an oil path structure that adjusts flow rate with a simple structure while ensuring reliable sealing.

The present invention provides an oil path structure including: a first member having a joint surface, and having a first oil path opened to the joint surface formed therein; a second member having a second oil path formed therein and joined to the joint surface such that the first oil path and the second oil path communicate with each other; an annular sealing member sealing between the first oil path and the second oil path; and an oil amount adjusting member limiting an amount of oil flowing through the oil path. The second member has an accommodating portion formed at a position adjacent to the joint surface and on route of the second oil path. In the accommodating portion, the annular sealing member in contact with the joint surface and the oil amount adjusting member positioned on a side of the annular sealing member opposite to the joint surface are arranged. The oil amount adjusting member is sandwiched between the annular sealing member and a wall surface of the second member defining the accommodating portion.

In the oil path structure formed as described above, the oil amount adjusting member is arranged together with the annular sealing member in the accommodating portion, and therefore, it becomes unnecessary to provide a portion for arranging the oil amount adjusting member separate from the accommodating portion. Further, the oil amount adjusting member is held sandwiched between the annular sealing member and a wall surface of the second member, and therefore, it is unnecessary to fix the oil amount adjusting member on the second member. Consequently, the process performed on the second member can be simplified, and the assembly of the oil amount adjusting member is facilitated. Further, the annular sealing member is provided between the joint surface of the first member and the oil amount adjusting member while being in contact with the joint surface, and therefore, sealing between the first and second oil paths can reliably be attained.

Preferably, the annular sealing member is an O-ring, and the oil amount adjusting member is a washer. In the oil path structure formed in this manner, commercially available parts can be used both for the annular sealing member and the oil amount adjusting member. Therefore, manufacturing cost can be reduced.

Further, cooling oil supplied to the electric motor is caused to flow through the first and second oil paths. By the oil path structure formed in this manner, the amount of cooling oil to be supplied to the electric motor can be adjusted to an appropriate amount in a simple structure, while reliable sealing is maintained.

As described above, according to the present invention, an oil path structure that allows flow rate adjustment with simple structure while ensuring reliable sealing can be provided.

### BRIEF DESCRIPTION OF THE DRAWINGS

FIG. 1 is a cross sectional view showing a power train (driving device) to which the oil path structure in accordance with an embodiment of the present invention is applied.

FIG. 2 is a cross sectional view showing, in enlargement, a position surrounded by a two-dotted line II in FIG. 1.

FIG. 3 is an exploded perspective view showing an assembly of a plain washer and an O-ring arranged in the recessed portion of FIG. 2.

FIG. 4 is a cross sectional view illustrating a force acting on the O-ring in the power train of FIG. 1.

FIG. 5 is a cross sectional view illustrating a force acting on the O-ring in a modification of the power train of FIG. 1.

### BEST MODES FOR CARRYING OUT THE INVENTION

An embodiment of the present invention will be described with reference to the figures. Throughout the drawings referred to in the following, the same or corresponding portions are denoted by the same reference numbers.

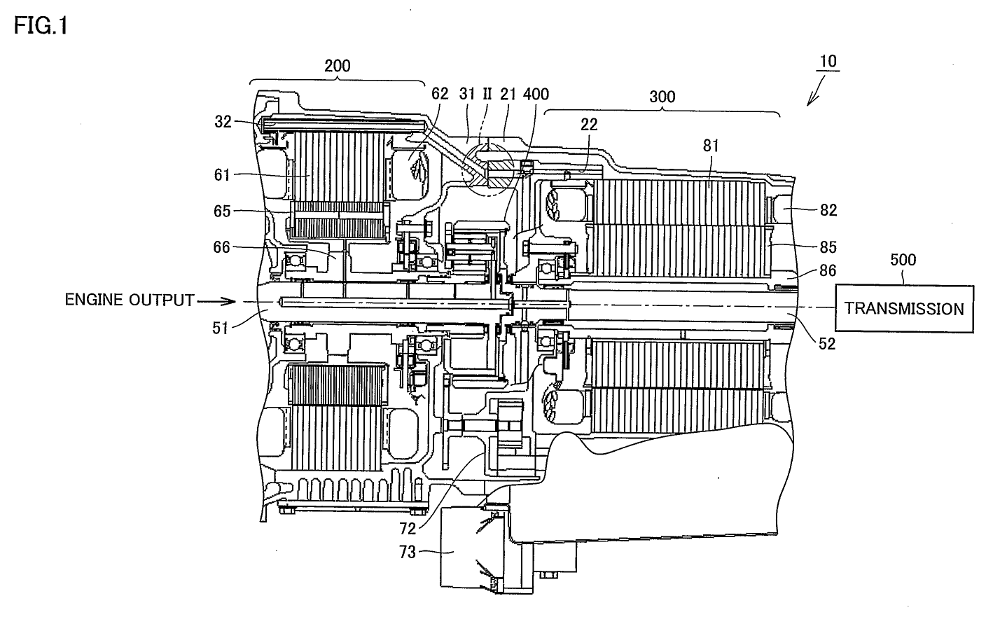

A power train shown in FIG. 1 is mounted on an FR (front engine rear wheel drive) hybrid car that has, as power sources, an internal combustion engine such as a gasoline engine or a diesel engine and a rechargeable secondary battery.

Referring to FIG. 1, a power train 10 includes a generator case 31 accommodating a motor generator 200, and a motor case 21 accommodating a motor generator 300 and assembled with generator case 31. Generator case 31 and motor case 21 have cylindrical shapes. Between motor generator 200 and motor generator 300, a power distributing mechanism 400 is arranged. On a side of motor generator 300 opposite to power distributing mechanism 400, an automatic transmission 500 is arranged.

Motor generator 200 is provided on the front side of the car, than motor generator 300. Motor generator 200 includes a stator 61 and a rotor 65. Stator 61 is fixed on an inner circumference of generator case 31 by fastening a bolt or the like. On generator case 31, a rotor shaft 66 is rotatably supported with a bearing interposed. Rotor 65 is fixed on rotor shaft 66.

Motor generator 300 includes a stator 81 and a rotor 85. Stator 81 is fixed on an inner circumference of motor case 21 by fastening a bolt or the like. On motor case 21, a rotor shaft 86 is rotatably supported with a bearing interposed. Rotor 85 is fixed on rotor shaft 86. Stators 61 and 81 are formed, for example, by a stator core of laminated sheet steel and a copper wire wound around a teeth portion of the stator core.

Power distributing mechanism 400 is formed of a set of planetary gear mechanism. Power distributing mechanism 400 is fixed on a shaft 51 connected to an output axis of the engine, on rotor shaft 66 of motor generator 200 and on a shaft 52 connected to automatic transmission 500.

With this arrangement, the power generated by the engine is fed by shaft 51 and divided into two paths by power distributing mechanism 400. One is a path that rotates shaft 52 and drives a rear drive shaft through automatic transmission 500, and the other is a path that rotates rotor shaft 66 as well as rotor 65 to produce electric power in motor generator 200.

Dependent of the state of running of the vehicle, motor generator 200 charges a battery, not shown, with the electric power generated by the engine power, or supplies the electric power to motor generator 300. At the start of engine operation, motor generator 200 functions as a starter, that is, an electric motor, that rotates the output axis of the engine and performs cranking.

Motor generator 300 operates with at least one of the electric power stored in the battery and the electric power generated by motor generator 200. Specifically, in motor generator 300, a magnetic field is generated as stator 81 receives electric power supply. The generated magnetic field rotates rotor 85, and shaft 52 rotates accordingly. The driving force of motor generator 300 generated in this manner is transmitted through automatic transmission 500 to the rear drive shaft. In this manner, motor generator 300 assists the driving power of the engine and realizes running of the vehicle with the electric power supplied from motor generator 200.

Power train 10 further includes an electric oil pump 73 and a mechanical oil pump 72 that operates receiving the driving power from the engine. In each of motor case 21 and generator case 31, a cooling oil path 22 and a cooling oil path 32 communicated with cooling oil path 22 are formed. The cooling oil fed with pressure from electric oil pump 73 or mechanical oil pump 72 passes through cooling oil path 22 and supplied to the stator core of stator 81 and to a coil end 82. Further, the cooling oil passes through cooling oil path 22 to cooling oil path 32, and supplied to the stator core of stator 61 and to a coil end 62.

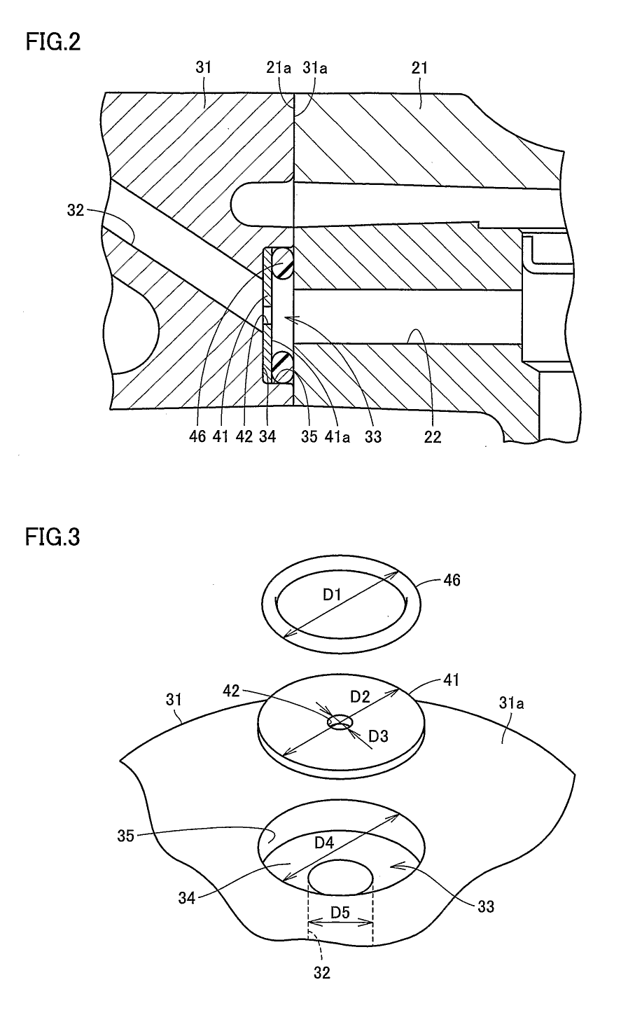

Referring to FIG. 2, motor case 21 has a joint surface 21a at which cooling oil path 22 is opened, and generator case 31 has a joint surface 31a at which cooling oil path 32 is opened. Toward joint surface 21a, cooling oil path 22 extends in a direction orthogonal to the joint surface 21a. Toward joint surface 31a, cooling oil path 32 extends in a direction diagonally crossing the joint surface 31a. Joint surfaces 21a and 31a are joined such that cooling oil paths 22 and 32 communicate with each other. At the position where cooling oil paths 22 and 32 are opened to each other, the cooling oil paths extend in mutually different directions.

Further, in generator case 31, a recessed portion 33 is formed at a position on route of cooling oil path 32. Recessed portion 33 is formed indented in columnar shape from joint surface 31a, and recessed portion 33 is defined by a bottom surface 34 extending parallel to the joint surface 31a at a prescribed depth from joint surface 31a, and a side surface 35 extending cylindrically between the circumferential edge of bottom surface 34 and joint surface 31a. Cooling oil path 32 approximately leads to the center of bottom surface 34. In recessed portion 33, a plain washer 41 and an O-ring 46 are arranged.

Referring to FIGS. 2 and 3, a hole 42 smaller in diameter than cooling oil paths 22 and 32 is formed in plain washer 41. Plain washer 41 is provided such that hole 42 is aligned with the opening of cooling oil path 32. Plain washer 41 abuts bottom surface 34. Plain washer 41 is formed of a metal such as iron or stainless steel. A commercially available washer may be used as plain washer 41.

O-ring 46 is provided on the side opposite to bottom surface 34 with respect to plain washer 41. O-ring 46 is arranged adjacent to plain washer 41 in a direction away from bottom surface 34. O-ring 46 is formed of an elastic member such as NBR (nitrile rubber). A commercially available O-ring may be used as O-ring 46, or an FIPG (Formed In Place Gasket) formed to have a ring-shape may be used.

When motor case 21 is assembled with generator case 31 with plain washer 41 and O-ring 46 arranged in recessed portion 33, plain washer 41 is held in recessed portion 33 as it is sandwiched between bottom surface 34 and O-ring 46. Further, O-ring 46 is pressed between plain washer 41 and joint surface 21a, and brought into pressure-contact both with side surface 35 and joint surface 21a. Consequently, sealing between cooling oil path 22 and cooling oil path 32 is established.

When we represent the outer diameter of O-ring 46 by D1, diameter of plain washer 41 by D2, diameter of hole 42 by D3, diameter of recessed portion 33 by D4 and diameter of cooling oil path 32 by D5, the relation “D1>D4>D2>D5>D3” is satisfied in the present embodiment. By way of example, D3 is 2 mm, D4 is 18 mm and D5 is 5 mm.

By such a structure, the flow rate of cooling oil coming from cooling oil path 22 to cooling oil path 32 is limited by plain washer 41. In the present embodiment, plain washer 41 is sandwiched between bottom surface 34 and O-ring 46 and held in recessed portion 33. Therefore, it is unnecessary to have plain washer 41 seated in recessed portion 33 by press-fitting (namely, dimensional setting of D4>D2 is possible). Accordingly, it is easy to arrange plain washer 41 in recessed portion 33. Further, at the position where plain washer 41 is arranged, processing accuracy of recessed portion 33 may be set rough, and therefore, processing of recessed portion 33 becomes easier.

When a commercially available washer is to be used as plain washer 41, there are washers of various hole diameters, allowing selection of an appropriate one. Therefore, the flow rate of cooling oil can be limited to the optimal amount.

O-ring 46 is provided in plane-contact (surface-to-surface contact) with plain washer 41 on the side opposite to joint surface 21a. Therefore, as compared with a member for limiting flow rate of cooling oil fixed on the cooling oil path by caulking, possibility of any damage to O-ring 46 during or after assembly is smaller. Therefore, reliability of sealing between cooling oil path 22 and cooling oil path 32 can be improved.

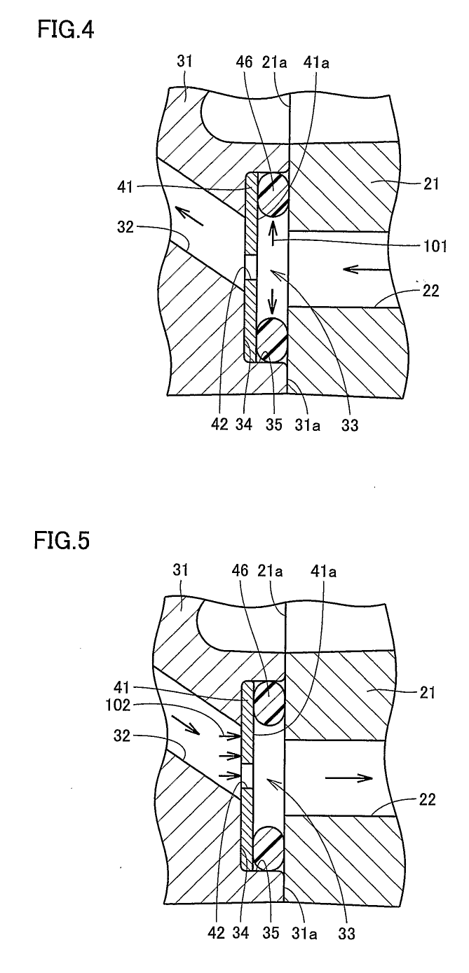

Referring to FIG. 4, in the present embodiment, O-ring 46 and plain washer 41 are arranged both on the upstream side and downstream side of the cooling oil flow. Therefore, at recessed portion 33 before the flow rate of cooling oil is limited by plain washer 41, the pressure of cooling oil increases, and hence, O-ring 46 is urged to side surface 35, as represented by an arrow 101. This improves tight sealing between cooling oil path 22 and cooling oil path 32.

Referring to FIG. 5, it is assumed that, in the example shown in the figure, the cooling oil flows from cooling oil path 32 to cooling oil path 22, and that plain washer 41 and O-ring 46 are arranged both on the upstream side and downstream side of the cooling oil flow. Here, the cooling oil flowing through cooling oil path 32 presses the surface of plain washer 41, and by the pressed plain washer 41, O-ring 46 is urged to joint surface 21a, as represented by an arrow 102. As a result, tight sealing between cooling oil path 22 and cooling oil path 32 can be improved.

The oil path structure of the present embodiment includes: motor case 21 as a first member having joint surface 21a and having cooling oil path 22 as the first oil path opened to joint surface 21a formed therein; generator case 31 as the second member having cooling oil path 32 as the second oil path formed therein and joined to joint surface 21a such that cooling oil path 22 and cooling oil path 32 communicate with each other; O-ring 46 as an annular sealing member sealing between cooling oil path 22 and cooling oil path 32; and plain washer 41 as an oil amount adjusting member limiting the amount of oil flowing through the cooling oil path. In generator case 31, at a position adjacent to joint surface 21a and on route of cooling oil path 32, recessed portion 33 as an accommodating portion is formed. In recessed portion 33, O-ring 46 in contact with joint surface 21a, and plain washer 41 positioned on the side of O-ring 46 opposite to joint surface 21a are arranged. Plain washer 41 is sandwiched between O-ring 46 and bottom surface 34 as a wall surface of generator case 31 defining the recessed portion 33.

In the oil path structure in accordance with the present embodiment as described above, plain washer 41 is arranged in recessed portion 33 together with O-ring 46. Therefore, it is unnecessary to provide the position for accommodating plain washer 41 separately on motor case 21 or generator case 31. Further, by appropriately selecting the diameter of hole 42, the flow late of cooling oil supplied to stator 61 can freely be changed. Therefore, it is unnecessary to use a drill of a particularly small diameter when cooling oil path 32 is processed. From these reasons, processing of motor case 21 and generator case 31 can be done quickly in a simple manner, and hence, manufacturing cost can be reduced.

Though recessed portion 33 in which O-ring 46 and plain washer 41 are arranged is formed in generator case 31, it may be formed in motor case 21. In that case also, first, plain washer 41 is arranged in recessed portion 33 and then O-ring 46 is arranged to be sandwiched between plain washer 41 and joint surface 31a.

Further, the oil path structure of the present invention is applicable not only to the cooling oil path through which the cooling oil flows but also to an oil path through which lubricant oil or hydraulic oil flows. The oil path structure of the present invention may be applied, for example, to an oil path between a valve body performing hydraulic pressure control of oil supplied to the automatic transmission and a strainer absorbing the oil in an oil pan to the valve body. When the valve body is formed by a combination of upper and lower bodies, the oil path structure may be applied to the oil path between the upper and lower bodies.

The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

### INDUSTRIAL APPLICABILITY

The present invention is mainly applicable to an oil amount adjusting mechanism provided on a vehicle.

1. An oil path structure, comprising:
a first member having a joint surface, and having a first oil path opened to said joint surface formed therein;
a second member having a second oil path formed therein and joined to said joint surface such that said first oil path and said second oil path communicate with each other;
an annular sealing member sealing between said first oil path and said second oil path; and
an oil amount adjusting member limiting an amount of oil flowing through an oil path; wherein
said second member has an accommodating portion formed at a position adjacent to said joint surface and on route of said second oil path,
in said accommodating portion, said annular sealing member (in contact with said joint surface and said oil amount adjusting member positioned on a side of said annular sealing member opposite to said joint surface are arranged,
said oil amount adjusting member is sandwiched between said annular sealing member and a wall surface of said second member defining said accommodating portion, and
a plane including a surface at which said first member and said second member abut each other and said wall surface at which said oil amount adjusting member and said second member abut each other are opposed to each other.

2. The oil path structure according to claim 1, wherein
said annular sealing member is an O-ring, and said oil amount adjusting member is a washer.

3. The oil path structure according to claim 1, wherein
cooling oil to be supplied to a motor generator is caused to flow through said first and second oil paths.

4. The oil path structure according to claim 1, wherein
said plane is a plane extending parallel to said wall surface.
